(19) United States
(12) Patent Application Publication
(10) Pub. No.: US 2008/0178746 A1
(43) Pub. Date: Jul. 31, 2008

(54) Waffle Iron Enabling a Top Baking Sub-Assembly to be Better Filled

(76) Inventors: Roger Rosset, Bloye (FR); Guillaume Prieto, Seynod (FR); Jerome Tranchant, Rumilly (FR)

Correspondence Address: BACHMAN & LAPOINTE, P.C., 900 CHAPEL STREET, SUITE 1201, NEW HAVEN, CT, 06510, US

(21) Appl. No.: 11/667,370

(22) PCT Filed: Nov. 8, 2005
(86) PCT No.: PCT/FR05/02786

§ 371 Date: Apr. 4, 2008

(30) Foreign Application Priority Data
Nov. 10, 2004 (FR) 0412003

(51) Int. Cl. A47J 37/06; A47J 37/00; A47J 37/01

(52) U.S. Cl. 99/380; 99/349; 99/447

(57) ABSTRACT

The inventive waffle iron comprises two baking sub-assemblies pivotable with respect to each other from an open position to a closed proximate position in which they define a baking chamber. The waffle iron also comprises at least one exhaust pipe provided with an orifice which is open above the central plane of the baking chamber when two baking sub-assemblies are in the closed proximate position thereof.

### BACKGROUND OF THE INVENTION

(1) Field of the Invention

The invention relates to a waffle iron or to any other similar electric baking appliance comprising two baking sub-assemblies pivotable with respect to one another.

(2) Prior Art

A household appliance is known of the type comprising an upper baking sub-assembly and a lower baking sub-assembly which are pivotable with respect to one another between an open position and a closed proximate position in which the two baking plates are opposite while the waffle iron does not have any food to bake, and in which the two baking sub-assemblies define a baking chamber.

It eventuates that, when the food to be baked is of the type tending to produce steam and swell under the action of the heat given off by the baking sub-assemblies, as is the case of waffle dough which can grow in size considerably (with a coefficient of 2 to 3 according to the ingredients utilised), the food tends to overflow from the baking sub-assemblies, which then dirties the household appliance and the work plane on which the latter rests, and produces waffles having unsightly edges, without even filling the whole baking chamber, the waffles having (almost) always a face (the one in contact with the upper baking sub-assembly) much less consistently cooked than the other. Also, the user often hesitates between increasing the quantity of dough so as to have a waffle with two equally developed sides as one another, causing considerable overflow of the dough, and reducing the quantity of dough to avoid any overflow, which produces waffles with a face almost without relief.

There are waffle irons available which can pivot on a stand, the user rocking the waffle iron during the baking operation so that over a certain period, each face of the waffle is the lower face, which allows it to expand. All the same, these waffle irons are, in general, quite complex, costly and require handling from the user which, even if not considered fastidious, can be forgotten.

The problem here is to produce an electrical appliance of the abovementioned type which is simple and can make dough-based foods (of waffle type) having on either side a relief corresponding to that of the baking plates carried by the baking sub-assemblies, without the user having to manipulate the appliance.

### SUMMARY OF THE INVENTION

According to the invention, the waffle iron of the type mentioned above comprises at least one exhaust pipe having an orifice terminating above the median plane of the baking chamber when the two baking sub-assemblies are in their closed proximate position, the median plane being defined as being the plane equidistant from the two baking plates carried by the two baking sub-assemblies, and, when the baking plates comprise a certain relief, the plane equidistant from the base planes of the two baking plates.

Therefore, due to this opening, the steam generated by the baking of the dough is evacuated from the baking chamber, and, the fact that the orifice is located above the median plane facilitates evacuation of the steam which has a tendency to accumulate in the top part of the baking chamber. Now, in household appliances of the prior art, no device was provided to facilitate evacuation of steam while in fact, it is the latter which, having accumulated in the top part of the baking chamber, prevents the dough from developing properly. So, according to the invention, since the water vapour is evacuated from the baking chamber the dough can fill the whole of the baking chamber.

### BRIEF DESCRIPTION OF THE DRAWINGS

Other particular features and advantages will emerge from the description of the embodiments given by way of non-limiting example and illustrated by the attached diagrams.

FIG. 1 is a schematic sectional view of a waffle iron according to a first embodiment of the present invention,

FIG. 2 is a schematic sectional view of a waffle iron according to a second embodiment of the present invention,

FIG. 3 is a schematic sectional view of a waffle iron according to a third embodiment of the present invention,

FIG. 4 is a sketch illustrating a particular aspect of the present invention.

FIG. 5 is a partial sectional view of a waffle iron according to the third embodiment, waffle dough having been placed on the lower baking plate, the two baking sub-assemblies being in their closed proximate position,

FIG. 6 is a view similar to FIG. 5, the dough having swollen to fill the entire upper baking plate, the two baking sub-assemblies being still in a closed proximate position,

FIG. 7 is a view similar to FIGS. 5 and 6, the dough having continued its expansion to where it spreads apart the two baking sub-assemblies, without any overflow,

FIG. 8 is a perspective view of a baking plate of the upper baking sub-assembly adapted to a waffle iron according to the third embodiment,

FIG. 9 is a schematic sectional view of the base of a throat of the baking plate of the upper baking sub-assembly according to a variant of the present invention, and

FIG. 10 is a partial sectional view illustrating the cooperation of the two baking plates at the level of the principal grooves delimiting different waffles originating from the same baking, according to a particular embodiment,

FIG. 11 is a sectional view of the two baking plates of a waffle iron according to another embodiment of the present invention,

FIG. 12 is an enlargement of the zone XII of FIG. 11, and

FIG. 13 is a partial schematic lateral elevation illustrating the cooperation between the two baking sub-assemblies according to a variant allowing simple extraction of a waffle.

### DETAILED DESCRIPTION OF THE PREFERRED EMBODIMENT(S)

A household appliance 1 (in this case a waffle iron 1) conventionally comprises an upper baking sub-assembly 2 and a lower baking sub-assembly 3 which are pivotable to one another by a hinge between an open position allowing the depositif of a food to be baked (in this case the dough) and the removal of the baked food (for example a waffle), and a closed proximate position in which the two baking sub-assemblies 2, 3 are opposite and define a baking chamber 4 for the food to be baked, the waffle iron 1 not holding dough to be baked.

Furthermore, each baking sub-assembly 2, 3 comprises a shell 5, 6 forming the body of the sub-assembly 2, 3, a baking plate 7, 8 adapted to receive and to bake the dough, and electrical heating resistance 9 which imparts to the baking plate 7, 8 the thermal energy necessary for baking. Conventionally for a waffle iron, each baking plate 7, 8 comprises teeth 10 oriented in the direction of the other baking plate 8, 7 when the two sub-assemblies 2, 3 are in their closed proximate position, and throats 11 which delimit these teeth 10.

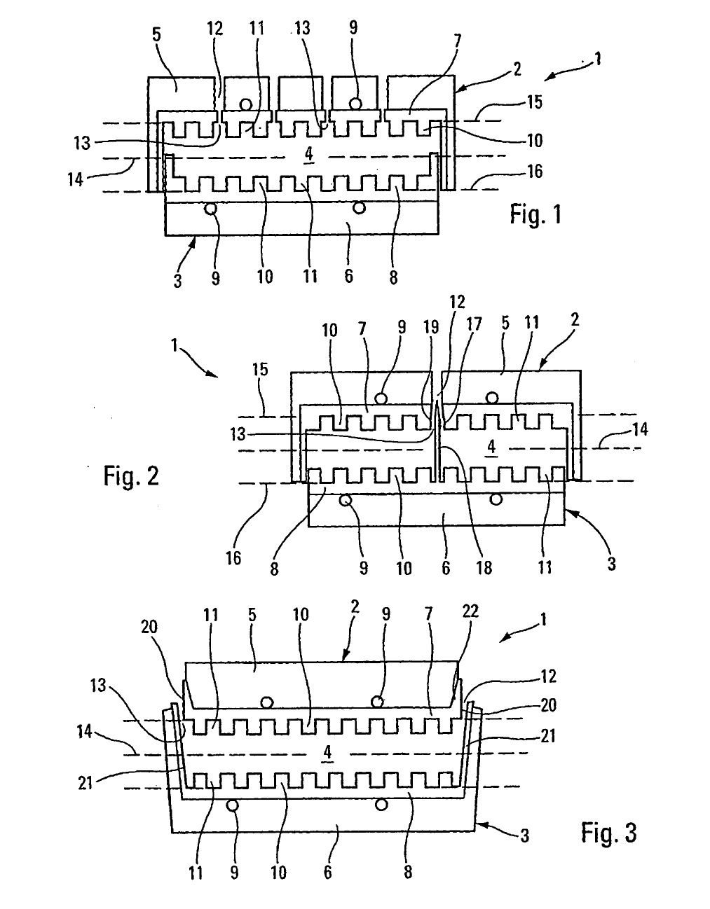

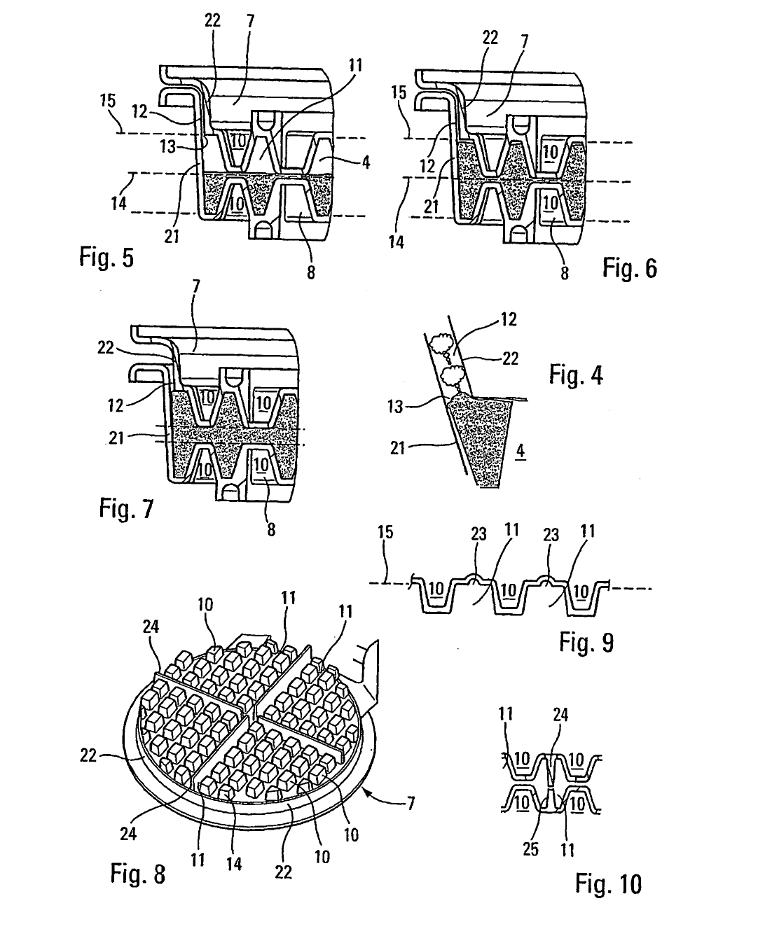

According to the invention, and as is evident from FIGS. 1 to 7, 11 and 12, the household appliance 1 comprises at least one exhaust pipe 12 having an orifice 13 terminating above the median plane 14 of the baking chamber 4 when the two baking sub-assemblies 2, 3 are in their closed proximate position. The median plane 14 of the baking chamber 4 is defined as being the plane equidistant from the two baking plates 7, 8 of the household appliance 1 when the baking sub-assemblies 2, 3 are in their closed proximate position, and more precisely, in the case of a waffle iron, the plane equidistant from the two base planes 15, 16 of the baking plates 7, 8, the base plane 15, 16 of a baking plate 7, 8 being the plane defined by the base of the throats 11 of this plate 7, 8.

The steam generated by the baking of the dough, which tends naturally to accumulate in the top part of the baking chamber 4 (in the case of a waffle iron, in the throats 11 of the upper baking plate 7), therefore escapes from the appliance by passing through the exhaust pipe 12.

Because steam always tends to accumulate at the apex of the baking chamber 4, the orifices 13 of the conduits 12 preferably terminate at a level closer to the base plane 15 of the upper baking plate 7 than the median plane 14. And better still, these orifices 13 terminate at the level of the base plane 15 of the upper baking plate 7.

According to the first embodiment illustrated in FIG. 1, the orifices 13 of exhaust pipes 12 are formed by openings 13 made in the upper baking sub-assembly 2, and more precisely at the apexes of the upper baking plate 7.

According to the embodiments illustrated in FIGS. 2 to 7, 11 and 12, the orifices 13 of the exhaust pipes 12 are formed by the spread, when the two baking sub-assemblies 2, 3 in their closed proximate position, between on the one hand a peripheral element 17, 20, 120 of the upper baking sub-assembly 2 and on the other hand a peripheral element 18, 21, 121 of the lower baking sub-assembly 3. When the two baking sub-assemblies 2, 3 are in their closed proximate position, they touch at certain points only, on the periphery of the baking plates 7, 8, such as to define the spread between the peripheral elements 17, 18, 20, 21, 120, 121.

According to the embodiments illustrated in FIGS. 2 to 7 the two peripheral elements 17, 18, 20, 21 nest inside one another.

In the embodiment illustrated in FIG. 2, the peripheral element 17 of the upper baking sub-assembly is formed by an opening 17 made in this sub-assembly 2 (in this instance in the upper baking plate 7), and that 18 of the lower baking sub-assembly 3 is formed by a peripheral inner wall 18 which is supported by this sub-assembly 3 and extends in the direction of the upper baking sub-assembly 2, beyond the median plane 14. The opening 17 made in the upper baking plate 2 forms the outer delimitation of the orifice 13, while the peripheral inner wall 18 of the lower baking sub-assembly 3 forms its internal delimitation.

Furthermore, the peripheral element 17 of the upper baking sub-assembly 2 is completed by a peripheral inner wall 19 which extends from the rim of the opening 13 in the direction opposite the lower baking sub-assembly 3, and thus substantially in the same direction as the peripheral inner wall 18 of the lower baking sub-assembly 3. Therefore, when the two baking sub-assemblies 2, 3 are in their closed proximate position, the peripheral inner wall 19 of the upper baking sub-assembly 2 and that 18 of the lower baking sub-assembly 3 nest inside one another so form the orifice 13 of an exhaust pipe 12.

The inner peripheral walls 18 carried by the lower baking plate 3 can serve as groove for separating waffles in the case of a baking plate 8 so as to serve as a mould for several waffles.

In the embodiment illustrated in FIGS. 3 to 7, the peripheral element 20 of the upper baking sub-assembly 2 is formed by the outer periphery 20 of this sub-assembly 2, and that 21 of the lower baking sub-assembly 3 is formed by a peripheral external wall 21 which is carried by this sub-assembly 3, enclosing the corresponding baking plate 8, and extending in the direction of the upper baking sub-assembly 2, beyond the median plane 14. The outer periphery 20 of the upper baking sub-assembly 2 forms the internal delimitation of the orifice 13, while the peripheral external wall 21 of the lower baking sub-assembly 3 forms its outer delimitation. When the two baking sub-assemblies 2, 3 are in their closed proximate position, they touch at certain points only on the periphery of the plates 7, 8, so as to define the spread between the peripheral elements 20, 21 of the baking sub-assemblies 2, 3.

Furthermore, the peripheral element 20 of the upper baking sub-assembly 2 is completed by a peripheral external wall 22 enclosing the corresponding baking plate 7, and extending from the outer periphery 20 of this sub-assembly 2 in the direction opposite the lower baking sub-assembly 3, and thus substantially in the same direction as the peripheral external wall 21 of the lower baking sub-assembly 3. Consequently, when the two baking sub-assemblies 2, 3 are in their closed proximate position, the peripheral external wall 22 of the upper baking sub-assembly 2 and that 21 of the lower baking sub-assembly 3 nest inside one another so as to form the orifice 13 of an exhaust pipe 2.

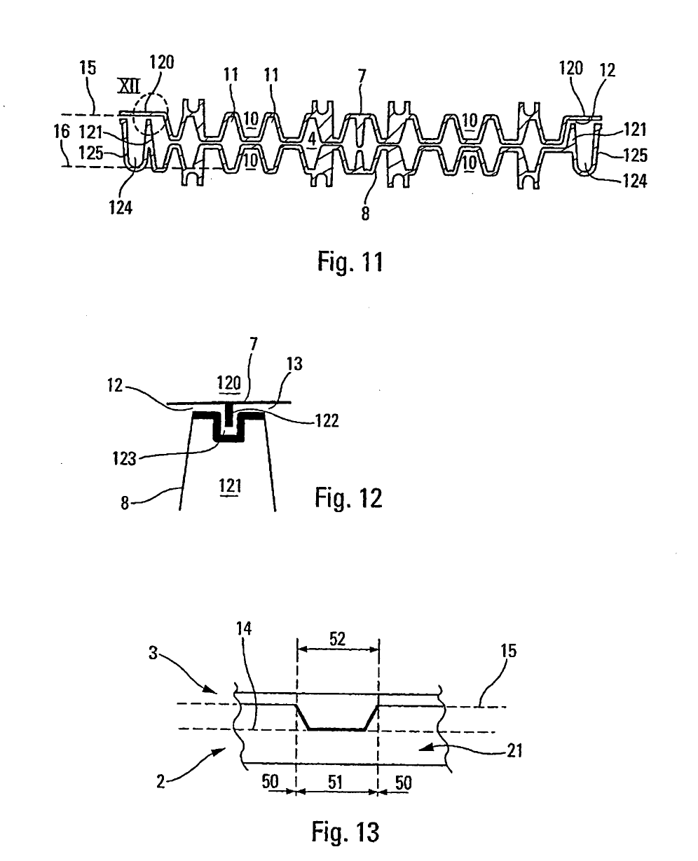

In the embodiment illustrated in FIGS. 11 and 12, the peripheral element 120 of the upper baking sub-assembly 2 is formed by an outer peripheral rim 120 of the upper baking plate 7, the rim 120 extending according to the base plane 15 and enclosing the baking zone defined as being the part of this plate 7 formed by teeth 10 and throats 11. The peripheral element 121 of the lower baking sub-assembly 3 is formed by a peripheral external wall 121 of the lower baking plate 8 surrounding the baking zone defined as being the part of this plate 8 formed by teeth 10 and throats 11, and extending in the direction of the peripheral rim 120, beyond the median plane 14. When the two baking sub-assemblies 2, 3 are in their closed proximate position, they touch at certain points only on the periphery of the plates 7, 8, to define the spread between the peripheral elements 120, 121 of the baking sub-assemblies 2, 3.

In the embodiments illustrated in FIGS. 2 to 7, 11 and 12, each peripheral wall 18, 22, 19, 21, 120, 121 is monobloc with the corresponding baking plate 7, 8. In addition, the orifice 13 delimited by the peripheral elements 17, 18, 20, 21, 120, 121 is made over the entire periphery of the baking sub-assemblies 2, 3.

In the case of an orifice 13 delimited by a single baking sub-assembly 2, as is the case in FIG. 1, if the orifice 13 is circular in shape, the direction to be taken into consideration is the diameter, and if the orifice 13 is a slot, the direction to be taken into consideration is its width, where its length can be any.

In the case of an orifice 13 delimited by two baking sub-assemblies 2, 3, as is the case in FIGS. 2 to 7, 11 and 12, the direction to be taken into consideration is the spread between the two peripheral elements 17, 18, 20, 21 when the two baking sub-assemblies 2, 3 are in their closed proximate position.

In addition, to facilitate evacuation of steam, the teeth 10 of the upper baking plate 3 terminate integrally, in height, in the orifice of the exhaust pipe. In the case of a plate 2 adapted to a waffle iron 1 such as illustrated by FIG. 3, where the orifice 13 of the exhaust pipe 12 is situated at the level of the base plane 15 of the upper baking plate 2, the upper baking plate 7 does not comprise a peripheral wall which extends from the base plane 15, in the direction of the lower baking plate 8 (as is evident from FIG. 8).

In addition, still in the interests of making it easier to evacuate steam, FIG. 9 illustrates a variant in which the upper baking plate 7 comprises steam exhaust ducts 23 which extend along the throats 11, at the base thereof (at the level of the base plane 15). These ducts 23 allow better circulation of steam. So that these ducts 23 are taken only by steam, their cross-section preferably has the same characteristics as those of the cross-section of the orifice 13 of the exhaust pipe 12 (cross-section less than 2 mm, or even less than 3 mm, and greater than 0.5 mm). Preferably also, these ducts 23 terminate directly in one of these orifices 13.

According to a particularly advantageous variant of the present invention, so as to prevent the dough from overflowing from the baking chamber 4, each orifice 13 forms a passage specific to the steam generated by the baking of the dough and has a cross-section insufficient to allow the dough to pass through. The cross-section of each orifice 13 preferably has, in one direction, a spread at most equal to 2 mm, or even 3 mm. In the interests of proper evacuation of the steam, it is preferable for this spread to be at least 0.5 mm.

In the embodiment illustrated in FIGS. 11 and 12, in order to disrupt flow of the dough out of the appliance 1, and thus improve the specificity of the passage 13 to steam, the upper baking plate 7 comprises, at the level of the two peripheral elements 120, 121, a chicane system placed over the entire periphery of the plates 7, 8. The chicane system comprises a wall 122 made on the peripheral rim 120 and a groove 123 made in the peripheral wall 121. So as not to slow down evacuation of the steam the wall 122 will preferably jut out by at most 2 mm relative to the rim 120; the chicane system can likewise be made only on certain parts of the periphery of the baking plates.

FIGS. 5 to 7 illustrate the process for baking a waffle in a waffle iron 1 according to the present invention.

After the waffle dough has been deposited on the lower baking plate 8, the upper baking sub-assembly 2 is closed over the dough, the two baking sub-assemblies 2, 3 then being in their closed proximate position (cf. FIG. 5).

As soon as the two baking sub-assemblies 2, 3 are in their closed proximate position, the baking of the dough causes generation of steam which is evacuated via the orifice 13 defined by the two outer peripheral walls 21, 22. Once the steam is evacuee, the dough can occupy the entire volume of the baking chamber 4 (cf. FIG. 6). Furthermore, in the waffle iron 1 illustrated by these figures, the cross-section 13 of the orifice is too narrow for the dough to be pulled out of the appliance 1.

As a result, due to its expansion the dough pushes the upper baking sub-assembly 2 upwards, until it reaches a closed spread position (cf. FIG. 7). In the waffle iron 1 illustrated in FIGS. 5 to 7, in a particularly advantageous manner, and irrespective of the position of the two baking sub-assemblies 2, 3 between their closed proximate position and a closed spread position, the orifice 13 forms a passage specific to steam. In this way, the hinge of the waffle iron 1 allows substantial vertical movement of the two baking sub-assemblies 2, 3 between the two closed positions.

Even when the two baking sub-assemblies 2, 3 move away from one another, the cross-section of the orifice 13 allows the steam to pass, but not the dough, thus preventing any overflow. Because of this, all surplus dough is integrated into the thickness of the waffle and is no longer ejected out of the appliance 1. Since this surplus dough which can be integrated can be relatively substantial, the limit being the amplitude of positions of the upper baking sub-assembly 2 in which the orifice 13 of the exhaust pipe 12 remains specific to the steam. It is thus possible to make original waffle recipes, such as for example, stuffed waffles made by depositing a first layer of dough on the lower baking plate 8, a layer of filling on the first layer of dough, and a second layer of dough on the layer of filling.

To avoid any excess of dough which might inevitably cause overflow (the amplitude of positions of the upper baking sub-assembly 2 being necessarily limited for a given waffle iron) or a lack of dough, the lower baking sub-assembly 3 preferably comprises an optimal level indicator of waffle dough. Such an indicator can be a step, a tooth having a specific height, or serigraph made for example on the peripheral external wall 21.

It should be noted that elevation of the upper baking sub-assembly 2 is done from a certain baking time, and that because of this when the upper baking sub-assembly is in a closed spread position, the dough no longer has the same fluidity as when it was in its closed proximate position. Accordingly, when the two baking sub-assemblies 2, 3 are in a closed spread position, the orifice 13 can be specific to steam, with different characteristics (less restrictive).

To make an orifice 13 specific to steam when the two baking sub-assemblies 2, 3 are between their closed proximate position and a closed spread position, the peripheral wall 21, 18 of the lower baking sub-assembly 2 (outer 21 and/or inner 18) extends slightly beyond the corresponding peripheral element 20, 17 supported by the upper baking sub-assembly 2 (outer periphery 20 and/or opening 17) when the two baking sub-assemblies 2, 3 are in this closed spread position. The peripheral wall (outer 22 and/or inner 19) of the upper baking sub-assembly 2 (wall extending from the outer periphery 20 and/or the opening 17) can extend to the very end of the corresponding peripheral wall 21, 18 of the lower baking sub-assembly 3 when the two baking sub-assemblies 2, 3 are in a closed proximate position.

The peripheral wall (outer 21 and/or inner 18) of the lower baking plate 3 preferably describes an angle of between 90° and 150° with the base plane 16 of the lower baking plate 8, and preferably between 92° and 100°, so that the spread between this peripheral wall and the corresponding peripheral element of the upper baking sub-assembly 2 (the outer periphery 20 and/or the opening 17) remains practically constant irrespective of the position of the two baking sub-assemblies 2, 3 between their closed proximate and spread positions. An angle of less than 92° risks generating wedging between the two peripheral elements 17, 18, 20, 21, and restricting upwards movement of the upper baking sub-assembly 2, and forcing the dough to pass through the orifice 13. An upper angle at 1000 substantially increases the spread between the two peripheral elements 17, 18, 20, 21 when the upper baking sub-assembly 2 is moved upwards, thus benefiting the passage of the dough in the orifice.

The peripheral wall (outer 22 and/or inner 19) of the upper baking sub-assembly 2 can also describe an angle having the same characteristics. It is clear that the more the peripheral walls 18, 21, 19, 22 of the two baking sub-assemblies 2, 3 have angles close to 900, the more the cross-section of passage of the orifice 13 remains constant.

Furthermore, to facilitate proper filling of the upper baking plate 7 during the baking stage, it is particularly recommended to distribute the dough evenly on the lower baking plate 8. In fact, if a zone of the lower baking plate 8 is barely covered in dough relative to the rest of the plate, the dough situated on this zone is further from the upper baking plate 7 than the rest of the dough. This dough is thus less warm. Due to the expansion of the rest of the dough in contact with the upper baking plate 7 and which pushes this plate 7 up, the portion of dough behind does not succeed in reaching the upper baking plate 7, thus receives less heat, and cannot catch up. Similarly, it is preferable for each baking sub-assembly 2, 3 to comprise a heating device adapted to distribute thermal energy over a majority of the surface of the corresponding baking plate 7, 8. In fact, the more the heat is uniformly distributed, the less there are zones abnormally hot or cold, the more the expansion of the dough is uniform.

In the case of a waffle iron 1 in which the two baking plates are etched so as to bake several waffles at the same time, the baking plates 7, 8 comprise principal grooves 24, 25 distinct from the teeth 10. To improve the homogeneous distribution of the dough on the lower baking plate 8, the principal grooves 25 of this plate 8 can be much thinner that the teeth 10; their thickness is preferably at most half, or even a third or a quarter of that of a tooth 10.

In the embodiment illustrated in FIG. 10, the principal grooves 25 of the lower baking plate 8 are not as high as the teeth 10 of this plate 8, whereas the principal grooves 24 of the upper baking plate 7 exceed the median plane 14 when the two baking sub-assemblies 2, 3 are in their closed proximate position.

So that the baking dough is not veritably divided by the principal grooves 24, 25, when the two baking sub-assemblies 2, 3 are in their closed proximate position, the principal upper grooves 24 are preferably not in contact with the principal lower grooves 25.

In the embodiment illustrated in FIG. 11, in order to prevent the dough overflowing out of the appliance 1, the lower baking plate 8 comprises a peripheral throat 124 which encloses the peripheral wall 121. This peripheral throat 124 is thus delimited, in the direction of the baking zone, by the peripheral wall 121, in the direction of the upper baking plate 7, by the peripheral rim 120 of the upper baking plate 7, and, in an outward direction of, by a peripheral rim 125 supported by the lower baking plate 8. Due to the fact of the situation of the exhaust pipe 12 at the level of the base plane 15 of the upper baking plate 7, this peripheral throat 124 has an equal depth clearly greater than the throats 11 of the baking plate. This depth can be equal to the distance separating the two base planes 15, 16 when the two baking sub-assemblies are in their closed proximate position.

In the embodiments where the peripheral external wall 21, 121 of the lower baking sub-assembly 3 extends well beyond the median plane 14 of the waffle iron 1, or even beyond the base plane 15 of the upper baking plate 2, over the entire periphery of the lower baking sub-assembly 3, the extraction of the waffle can prove to be particularly delicate.

To facilitate this extraction, several systems are possible:
the lower baking plate 8 can be separable from the lower baking sub-assembly 3 and from the peripheral external wall 21 (optionally from the peripheral inner wall 18), and comprise a prehensile organ facilitating its handling.
the lower baking sub-assembly 3 can comprise a mobile lever between a rest position in which it rests on the lower baking plate 8, and an activated position in which it projects upwards, bringing the waffle with it.
the two baking plates 7, 8 can have an anti-adhesive coating, the adhesive capacity of that deposited on the upper baking plate 7 being greater than that deposited on the lower baking plate 8, the waffle thus having a tendency to remain hooked onto the upper baking plate 7 from where it can easily be detached.
each baking plate 7, 8 can have teeth 10 having shapes particular to it, those of the upper baking plate 7 able to comply so as to favour gripping the waffle, while those of the lower baking plate 8 can conform so as to favour its detachment.

As illustrated in FIG. 13, the peripheral external wall 21 of the lower baking sub-assembly 3 can comprise, so as to define access to the flank of the waffle, a main part 50 which, over around 300° (or even more), extends beyond the median plane 14 of the waffle iron 1 (or even beyond the base plane 15 of the upper baking sub-assembly 2), and a complementary part 51 which extends as far as the median plane 14, over around 60° (or even less), the complementary part 51 of the peripheral external wall of the lower sub-assembly 3 being able to comprise a seal cooperating with a corresponding part 52 of the peripheral external wall of the upper baking sub-assembly 2 so as not to create a passage by which the dough might escape. It would be possible for the complementary part 51 of the peripheral external wall 21 of the lower baking sub-assembly 3 not to reach the median plane, the corresponding part 52 of the peripheral external wall of the upper baking sub-assembly 2 then complying so as to make the desired seal.

To allow the steam to escape more easily it would be possible for the base of the upper baking plate 8 defined by the base of the throats 11, in place of extending according to a plane (the base plane 15 in the present embodiments), to exhibit an adequate curve (the closer the base is to an orifice 13, the further away it is from the median plane 14 of the waffle iron 1).

1-18. (canceled)

19. A household appliance comprising an upper baking sub-assembly and a lower baking sub-assembly pivotable with respect to one another between an open position and a closed proximate position in which they define a baking chamber, at least one exhaust pipe having an orifice terminating above a median plane of the baking chamber when the two baking sub-assemblies are in the closed proximate position.

20. The household appliance as claimed in claim 19, wherein said orifice terminates at a level closer to a base plane of a baking plate carried by the upper baking sub-assembly than to the median plane.

21. The household appliance as claimed in claim 20, wherein the orifice of said exhaust pipe is formed by an opening made in the baking plate carried by the upper baking sub-assembly.

22. The household appliance as claimed in claims 20, wherein the orifice of the exhaust pipe is formed by a spread, when the two baking sub-assemblies are in the closed proximate position, between a peripheral element of the upper baking sub-assembly cooperating with a corresponding peripheral element of the lower baking sub-assembly.

23. The household appliance as claimed in claim 22, wherein the peripheral element of the upper baking sub-assembly is formed by an opening made in the baking plate carried by the upper baking sub-assembly and which forms an outer delimitation of the orifice, the peripheral element of the lower baking sub-assembly being formed by a peripheral inner wall which is carried by the lower baking sub-assembly, which extends in the direction of the opening beyond the median plane, and which forms the internal delimitation of the orifice.

24. The household appliance as claimed in claim 23, wherein the peripheral element of the upper baking sub-assembly is formed by the outer periphery of said upper baking sub-assembly which forms the internal delimitation of the orifice, the peripheral element of the lower baking sub-assembly being formed by a peripheral external wall which is carried by the lower baking sub-assembly, which extends in the direction of the outer periphery of the upper baking sub-assembly beyond the median plane, and which forms the outer delimitation of the orifice.

25. The household appliance as claimed in claim 23, wherein each peripheral wall describes an angle between 92° and 100° with the corresponding baking plate.

26. The household appliance as claimed in claim 23, wherein each peripheral wall of a baking sub-assembly is monobloc with the corresponding baking plate.

27. The household appliance as claimed in claim 23, wherein the lower baking plate comprises a prehensile organ and is separable from the peripheral wall of the lower baking sub-assembly.

28. The household appliance as claimed in claim 22, wherein when the baking sub-assemblies are in their closed proximate position, each peripheral element of the lower baking sub-assembly extends beyond a plane defined by the corresponding peripheral element of the upper baking plate.

29. The household appliance as claimed in claim 19, wherein said orifice forms a passage specific to steam generated by a baking of a dough placed in the baking chamber and the cross-section of said orifice being insufficient to allow passage of the dough.

30. The household appliance as claimed in claim 29, wherein the cross-section of each orifice presents, in one direction, a spread at most equal to 3 mm.

31. The household appliance as claimed in claim 29, wherein irrespective of the position of the two baking sub-assemblies between their closed proximate position and a closed spread position in which the two baking plates are moved apart from one another under the action of the expansion of the dough, said orifice forms a passage specific to steam.

32. The household appliance as claimed in claim 20, wherein the baking plate carried by the upper baking sub-assembly comprises teeth and throats which delimit the teeth from one another and terminate integrally, in height, in the orifice of the exhaust pipe.

33. The household appliance as claimed in claim 32, wherein the baking plate carried by the upper baking sub-assembly comprises steam exhaust ducts which extend along throats in a base of the latter.

34. The household appliance as claimed in claim 33, wherein each exhaust duct terminates in an orifice.

35. The household appliance as claimed in claim 33, wherein each exhaust duct has a cross-section of less than 3 mm.

36. The household appliance as claimed in claim 20, wherein the adherent capability of the baking plate carried by the upper baking sub-assembly is more important than that of a baking plate carried by the lower baking sub-assembly.
